(19) United States
(12) Patent Application Publication
(10) Pub. No.: US 2009/0089120 A1
(43) Pub. Date: Apr. 2, 2009

(54) ADVERTISEMENT PROCESSING METHOD, ADVERTISEMENT DISPLAY METHOD, AND CONTACT ADVERTISEMENT PRESENTATION SYSTEM

(76) Inventor: Yasuyuki TERUI, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/021,742

(22) Filed: Jan. 29, 2008

(30) Foreign Application Priority Data
Feb. 19, 2007 (JP) JP2007-037296

(51) Int. Cl. G06Q 50/00; G06Q 30/00

(52) U.S. Cl. 705/7; 705/14

(57) ABSTRACT

An advertisement processing method by accepting an extraction request including a customer ID of a particular customer and conditions relating to products that are handled by a store and may be purchased by the particular customer, accessing a contact advertisement data storage in which advertisement contact situation data including data relating to advertisements registered by customers as correlated with customer IDs of the customers and data relating to situations in which the customers came into contact with the respective advertisements are stored, searching the contact advertisement data storage by the customer ID of the particular customer and the conditions relating to the products that are handled by the store and may be purchased by the particular customer, extracting suitable advertisement contact situation data, and outputting information about the extracted advertisement contact situation data.

### CROSS-REFERENCE TO RELATED APPLICATIONS

This application is related to and claims priority to Japanese patent application no. 2007-37296 filed on Feb. 19, 2007 in the Japan Patent Office, and incorporated by reference herein.

### BACKGROUND

### Field

The present invention relates to a technique for utilizing advertisements effectively. More specifically, the invention relates to a technique for re-presenting an advertisement that a consumer was interested in.

### SUMMARY

An advertisement processing method according to a first aspect of the present invention is an advertisement processing method which is performed by a computer capable of accessing a contact advertisement data storage section in which advertisement contact situation data including data relating to advertisements registered by customers so as to be correlated with customer IDs of the customers and data relating to situations in which the customers came into contact with the respective advertisements are stored, the advertisement processing method including accepting an extraction request including a customer ID of a particular customer and conditions relating to products that are handled by a store and may be purchased by the particular customer; and searching the contact advertisement data storage section by the customer ID of the particular customer and the conditions relating to the products that are handled by the store and may be purchased by the particular customer, and extracting suitable advertisement contact situation data based upon the searching, and outputting information about, for example, at least part of the advertisement extracted contact situation data.

An advertisement display method according to a second aspect of the invention is an advertisement display method which is performed by a store computer used in a store, including acquiring a customer ID of a particular customer; acquiring conditions relating to products that are handled by the store and may be purchased by the particular customer; sending an extraction request including the customer ID of the particular customer and the conditions relating to the products that are handled by the store and may be purchased by the particular customer to a contact advertisement processing server which holds advertisement contact situation data including data relating to advertisements registered by the particular customer and data relating to situations in which the particular customer came into contact with the respective advertisements; receiving at least part of advertisement contact situation data that conform to the extraction request and storing them in a storage device; and displaying at least part of the advertisement contact situation data stored in the storage device to the particular customer.

A contact advertisement presentation system according to a third aspect of the invention comprises a contact advertisement processing apparatus and a store computer system used in a store. The store computer system comprises first means for acquiring a customer ID of a particular customer; second means for acquiring conditions relating to products that are handled by the store and may be purchased by the particular customer; and third means for sending, to the contact advertisement processing apparatus, an extraction request including the customer ID of the particular customer and the conditions relating to the products that are handled by the store and may be purchased by the particular customer. The contact advertisement processing apparatus comprises a contact advertisement data storage section in which advertisement contact situation data including data relating to advertisements registered by customers so as to be correlated with customer IDs of the customers and data relating to situations in which the customers came into contact with the respective advertisements are stored; means for receiving the extraction request including the customer ID of the particular customer and the conditions relating to the products that are handled by the store and may be purchased by the particular customer; and extracting means for searching the contact advertisement data storage section by the customer ID of the particular customer and the conditions relating to the products that are handled by the store and may be purchased by the particular customer, extracting suitable advertisement contact situation data, and outputting at least part of the extracted advertisement contact situation data to the store computer system. The store computer system further comprises fourth means for receiving the at least part of the advertisement contact situation data from the contact advertisement processing apparatus, and storing them in a storage device; and fifth means for displaying at least part of the advertisement contact situation data stored in the storage device to the particular customer.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 outlines a system according to an embodiment of the present invention;

FIGS. 2A-2D are first to fourth parts of a flowchart of a contact advertisement data registration process;

FIG. 3 shows an exemplary advertisement medium selection picture;

FIG. 4 shows an exemplary channel selection picture;

FIG. 5 shows exemplary data stored in a broadcast advertisement DB;

FIG. 6 shows an exemplary advertisement list picture;

FIG. 7 shows exemplary data stored in a contact situation DB;

FIG. 8 shows exemplary data stored in an outdoor advertisement DB;

FIG. 9 shows an exemplary advertisement selection picture;

FIG. 10 shows another exemplary advertisement selection picture;

FIG. 11 shows an exemplary detailed information display picture which is displayed in registering contact advertisement data;

FIG. 12 shows another piece of exemplary data stored in the contact situation DB;

FIGS. 13A-13C are first to third parts of a flowchart of an advertisement display process;

FIG. 14 shows exemplary data stored in a goods DB;

FIG. 15 shows exemplary data stored in a handling candidate goods DB;

FIG. 16 shows an exemplary advertisement display map;

FIG. 17 shows exemplary data stored in a display rack layout DB;

FIG. 18 shows an exemplary detailed information display picture for display of an advertisement;

FIG. 19 shows the configuration of another store system; and

FIG. 20 is a functional block diagram of a computer as a contact advertisement processing server.

### DETAILED DESCRIPTION OF THE PREFERRED EMBODIMENTS

Consumers get information of goods etc. everyday from many advertisements on billboards and in broadcasts such as TV broadcasts. Therefore, even if a consumer sees an advertisement and is interested in a product or the like of the advertisement, he or she cannot keep that impression forever. That is, since the consumer sees other advertisements immediately thereafter, even if the consumer later goes to a store that actually sells the product or the like he or she was interested in, the consumer in many cases passes by the product or the like without remembering it.

For example, JP-A-2002-92360 discloses a technique that allows a consumer to be given specific information (e.g., a name, maker, and brand) of an article that was used in a TV broadcast or the like even if the consumer did not know it and to purchase it over a network. More specifically, a user terminal accesses a terminal of an information presenting company and then to a homepage of a broadcast program. The user reproduces a scene of the broadcast program through a picture displayed on the user terminal, finds an article the user is interested in, and, if he or she wants to purchase it, sends article order information generated through the picture to a server of the information presenting company over the network. The server of the information presenting company receives the order information and requests a server of a store to sell the ordered article. The server of the store instructs a server of a distribution center to deliver the article ordered by the server of the information presenting company. The distribution center dispatches the article to the user (the person who ordered). However, the technique of this publication assumes that a consumer roughly remembers a product and orders it on the basis of that memory. This technique cannot accommodate a case that a consumer forgot a product.

The technique of the above publication cannot accommodate a case that a consumer forgot an advertisement or a product relating to the advertisement. In the modern society which is full of a wide variety of advertisements, even if a consumer is re-presented with only an advertisement, the consumer in many cases cannot remember an impression he or she had when he or she was interested in the advertisement. In particular, the consumer in many cases cannot remember why he or she was interested in the advertisement. This is loss of a chance to the seller of the product.

An example object of the present invention is therefore to provide a technique for presenting an advertisement or a product or the like relating to the advertisement in which a customer was interested in the past, in such a manner that the customer can remember a situation in which he or she felt interest.

Another example object of the invention is to provide a technique for actualizing latent demand of customers and thereby reducing the loss of chances.

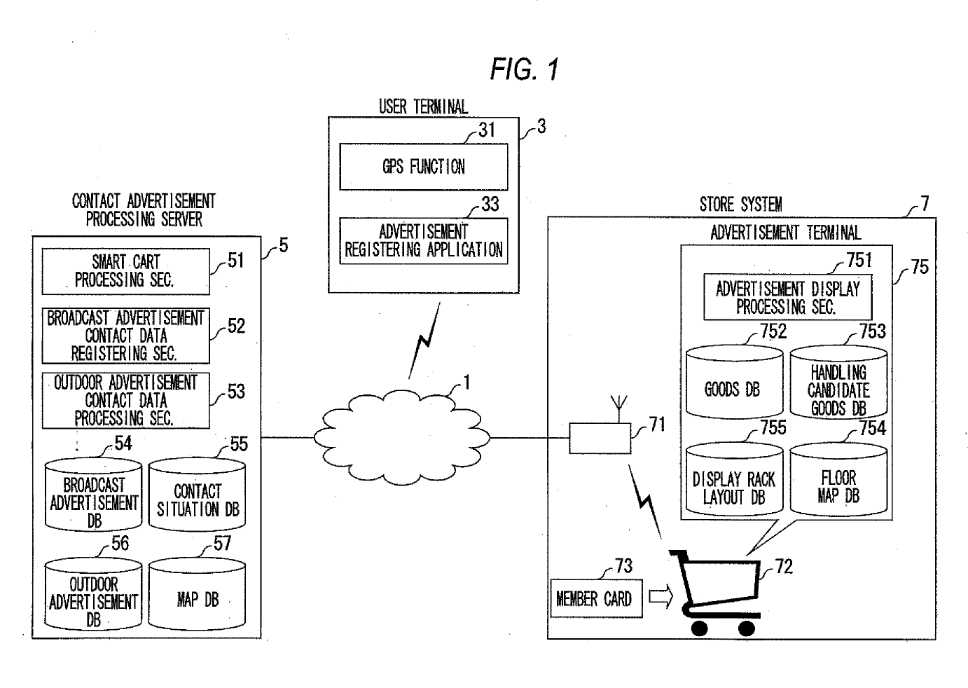

FIG. 1 outlines a system according to an embodiment of the invention. Plural user terminals 3, a contact advertisement processing server 5, and a store system 7 including one or plural stores are connected to a network 1 such as the Internet. Each user terminal 3 may be a terminal such as a cell phone or a PDA (personal digital assistant) or a terminal apparatus such as a personal computer. In the example of FIG. 1, each user terminal 3 is a cell phone which has a GPS (global positioning system) function 31 and can run an advertisement registering application program 33. Although only one user terminal 3 is shown in FIG. 1, it is assumed that there exist plural terminal devices of plural users who are membership-registered in the contact advertisement processing server 5.

The contact advertisement processing server 5 is equipped with a smart cart processing section 51 which performs processing in response to a request from a smart cart in the store system 7, a broadcast advertisement contact data registering section 52 which performs processing of registering contact data relating to an advertisement that was broadcast by television or radio, according to an instruction from a user terminal 3, an outdoor advertisement contact data registering section 53 which performs processing of registering contact data relating to an outdoor advertisement according to an instruction from a user terminal 3, a broadcast advertisement database (DB) 54 in which data relating to broadcast advertisements are accumulated, an outdoor advertisement DB 56 in which data relating to outdoor advertisements are accumulated, a map DB 57 in which map data are stored, and a contact situation DB 55 in which data relating to advertisement contact situations of members are accumulated.

The store system 7 is provided with one or plural radio base stations 71 each including a device for connection to the network 1 and plural smart carts 72 which communicate with the radio base station(s) 71. Each smart cart 72 is equipped with an advertisement terminal 75 having a reading device for reading a customer ID etc. from a member card 73 and a display device. The advertisement terminal 75 is equipped with an advertisement display processing section 751 which performs main pieces of processing in the advertisement terminal 75, a goods database 752 in which data relating to goods handled are stored, a handling candidate goods DB 753 in which data relating to goods that are not being handled but customers are interested in are accumulated, a display rack layout DB 755 in which data relating to layout of display racks in the store are stored, and a floor map DB 754 in which data of floor charts of the store are stored.

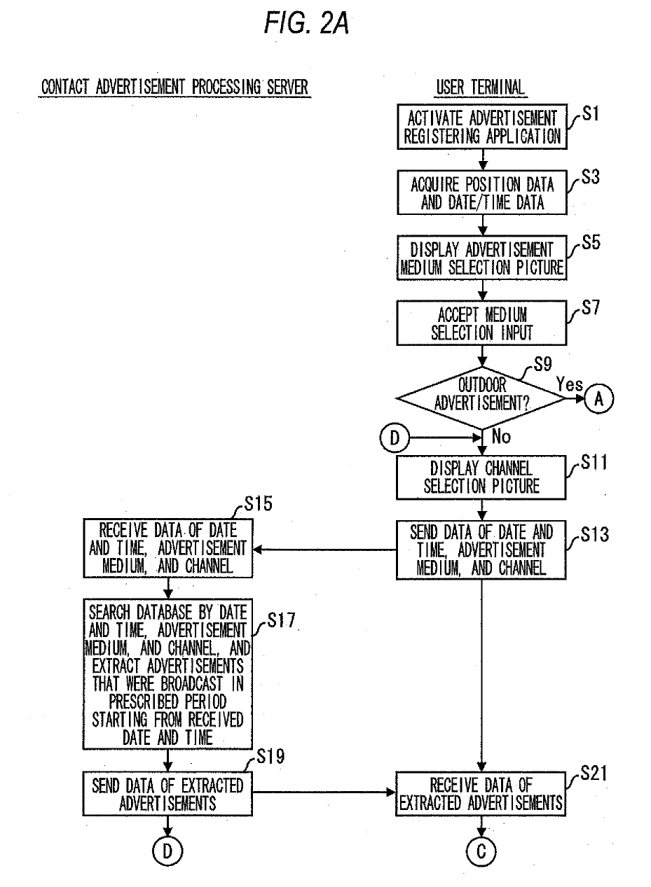

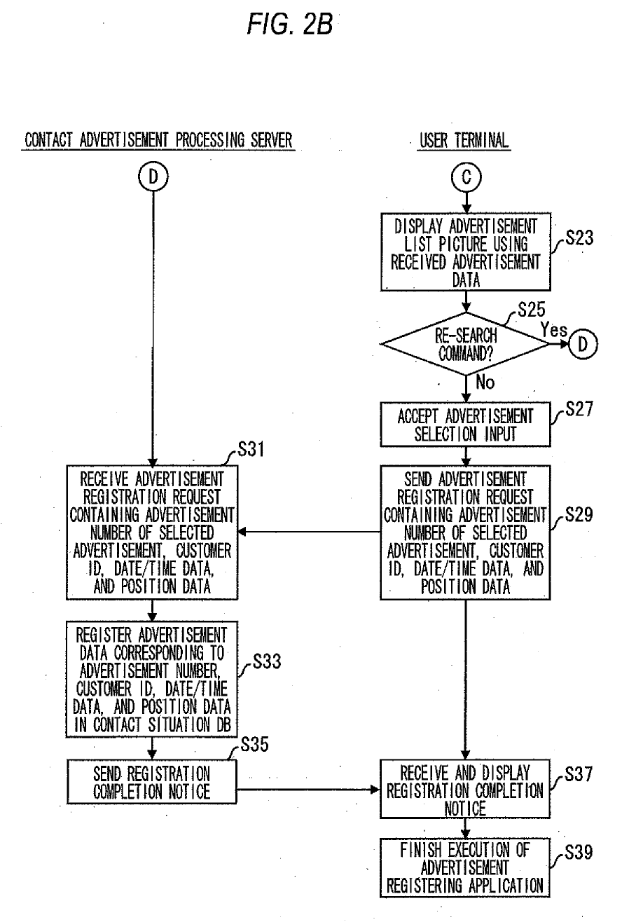

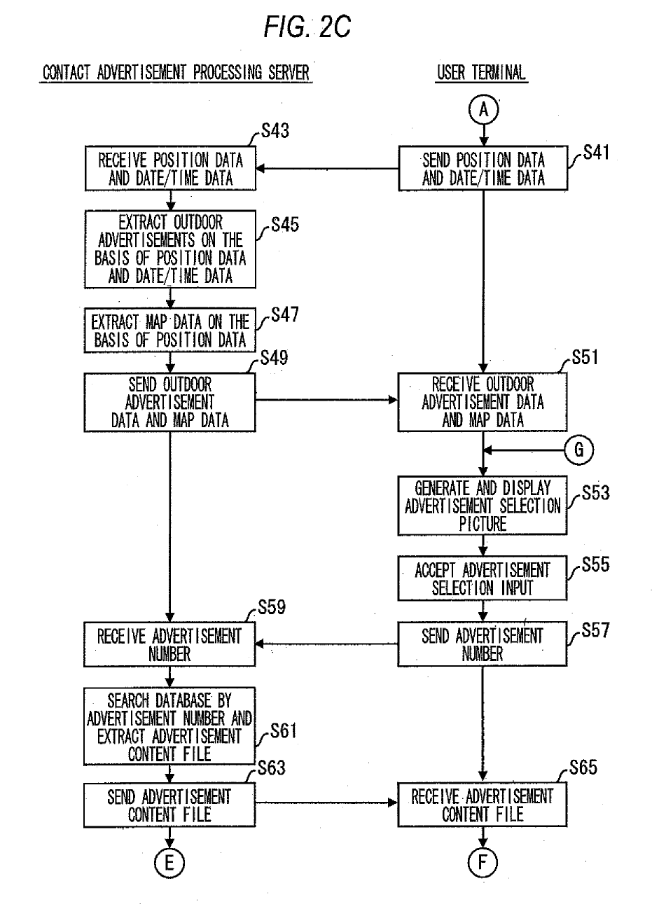

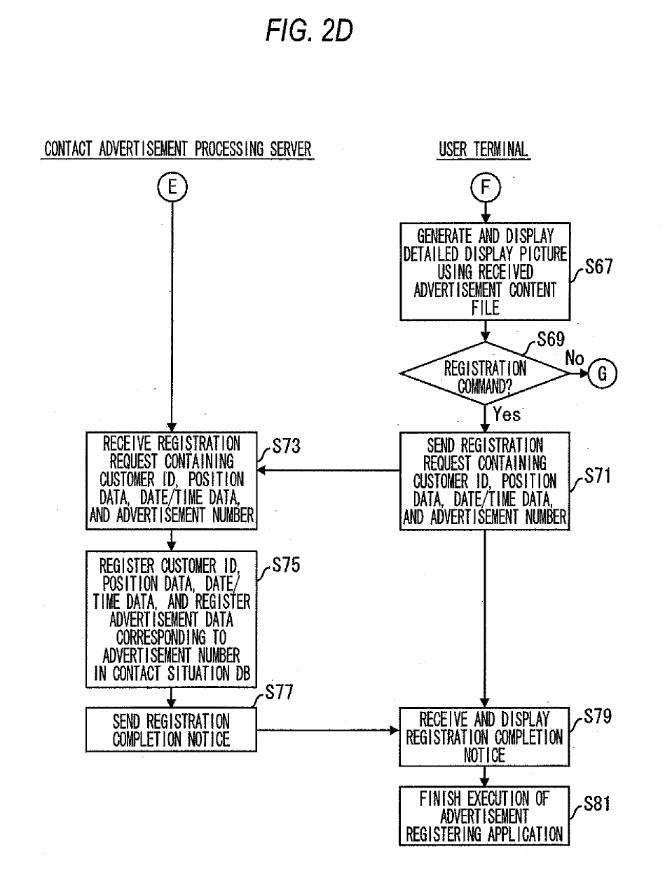

Next, a process which is executed in the system of FIG. 1 will be described with reference to FIGS. 2A-2D to FIG. 19. First, as shown in FIG. 2A, at S1, if a user who is a member of the contact advertisement processing server 5 finds an advertisement he or she is interested in, the user activates the advertisement registering application program 33 which is held by the user terminal 3 by manipulating the user terminal 3. The advertisement registering application program 33 has the following specific function.

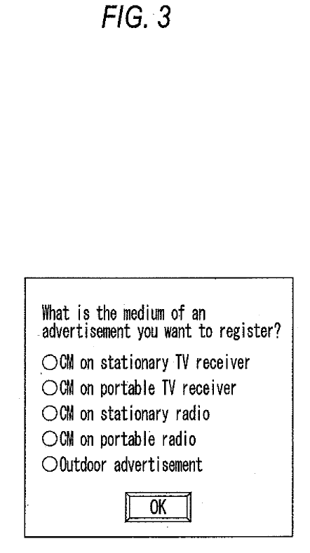

When activated, at S3, the advertisement registering application program 33 acquires current position data (e.g., a latitude and a longitude) and date/time data from the GPS function 31 of the user terminal 3. At S5, the advertisement registering application program 33 causes the display device to display an advertisement medium selection picture (user interface). For example, a picture as shown in FIG. 3 is displayed. In the example of FIG. 3, radio buttons are provided so as to enable selection of one of items “advertisement on a stationary TV receiver,” “advertisement on a portable TV receiver,” “advertisement on a stationary radio,” “advertisement on a portable radio,” and “outdoor advertisement.” The user selects one medium and clicks on an OK button.

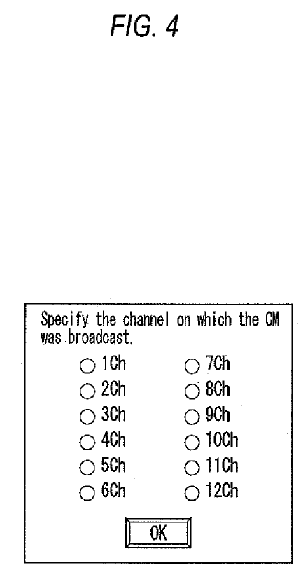

The advertisement registering application program 33 accepts the medium selection input of the user at S7 and judges at S9 whether the item “outdoor advertisement” has been selected. If “outdoor advertisement” has been selected, a different kind of process should be executed and the process moves to a part shown in FIG. 2C via diagram connection terminal A. On the other hand, a broadcast medium has been selected such as “advertisement on a stationary TV receiver,” advertisement on a portable TV receiver, “advertisement on a stationary radio,” or “advertisement on a portable radio,” at S11 the advertisement registering application program 33 causes the display device to display a channel selection picture. For example, a picture as shown in FIG. 4 is displayed. In the example of FIG. 4, possible channels of the specific medium selected are listed and radio buttons are provided so as to enable selection of one of those channels. The user selects a suitable channel and clicks on an OK button. The advertisement registering application program 33 of the user terminal 3 accepts the channel selection input of the user.

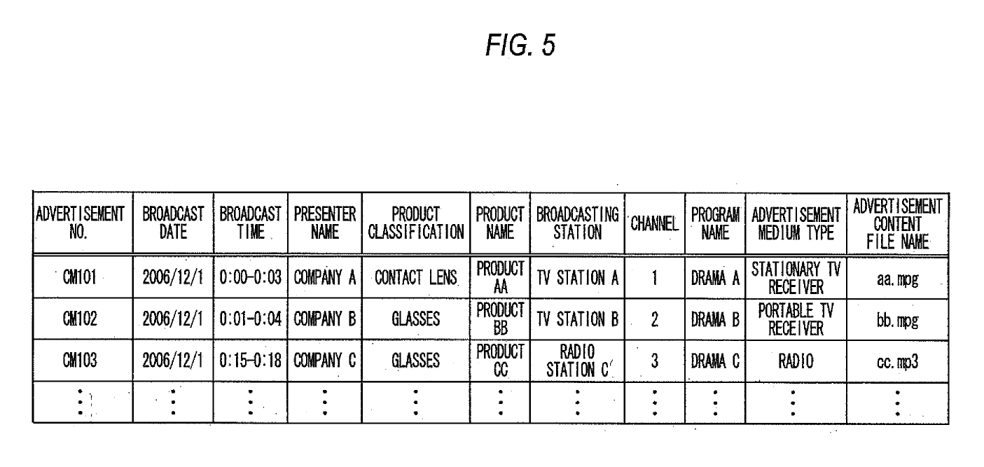

At S13, the advertisement registering application program 33 causes the user terminal 3 to send data of the date and time, the advertisement medium type, and the channel to the contact advertisement processing server 5. At S15, the broadcast advertisement contact data registering section 52 of the contact advertisement processing server 5 receives the data of the date and time, the advertisement medium type, and the channel from the user terminal 3 and stores the data in a storage device such as a main memory. At S17, the broadcast advertisement contact data registering section 52 searches the broadcast advertisement DB 54 by the date and time, the advertisement medium type, and the channel and extracts advertisements that were broadcast in a prescribed period starting from the received date and time. For example, data as shown in FIG. 5 are stored in the broadcast advertisement DB 54. In the example of FIG. 5, an advertisement number, a broadcast date, a broadcast time, a presenter name, a product classification, a product name, a broadcasting station, a channel, a program name, an advertisement medium type, and an advertisement content file name (or a storage location) are registered for each advertisement broadcasting event. An advertisement content file itself is also stored in the broadcast advertisement DB 54.

At S19, the broadcast advertisement contact data registering section 52 of the contact advertisement processing server 5 sends at least part of the advertisement data of each extracted advertisement (e.g., an advertisement number, presenter name, product classification, product name, broadcasting station, and program name) to the user terminal 3. At S21, the advertisement registering application program 33 of the user terminal 3 receives the advertisement data of the extracted advertisements from the contact advertisement processing server 5 and stores the data in a storage device such as a main memory. Then, the process moves to a part shown in FIG. 2B via diagram connector terminals B and C.

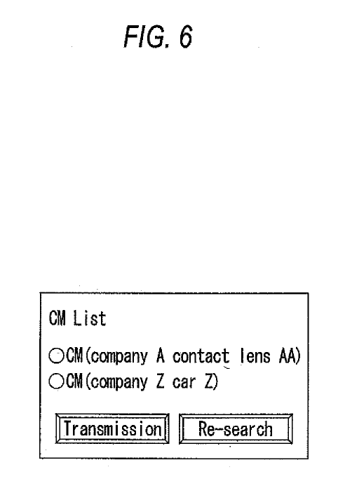

The part of the process shown in FIG. 2B will be described below. At S23, the advertisement registering application program 33 of the user terminal 3 generates an advertisement list picture using the received advertisement data and causes the display device to display the picture. For example, a picture as shown in FIG. 6 is displayed on the display device. In the example of FIG. 6, a list of two advertisements is displayed in which a presenter name, a product classification, and a product name are shown for each advertisement. Although not shown in FIG. 6, a broadcasting station and a program name may also be displayed. In this example, radio buttons for selection of one of the advertisements, a transmission button for commanding transmission, and a re-search button for initiating a re-search are provided.

If the user clicks on the re-search button, the advertisement registering application program 33 of the user terminal 3 accepts the re-search command (S25: yes) and the process returns to S11 in FIG. 2A via diagram connector terminal D. On the other hand, if finding a suitable advertisement in the advertisement list picture (S25: no), the user selects that advertisement and clicks on the transmission button. At S27, the advertisement registering application program 33 of the user terminal 3 accepts the advertisement selection input of the user. At S29, the advertisement registering application program 33 causes the user terminal 3 to send, to the contact advertisement processing server 5, an advertisement registration request containing the advertisement number of the selected advertisement, a customer ID (e.g., member number), and the date/time data and the position data that were acquired at S3. The received advertisement data itself may be returned instead of the advertisement number.

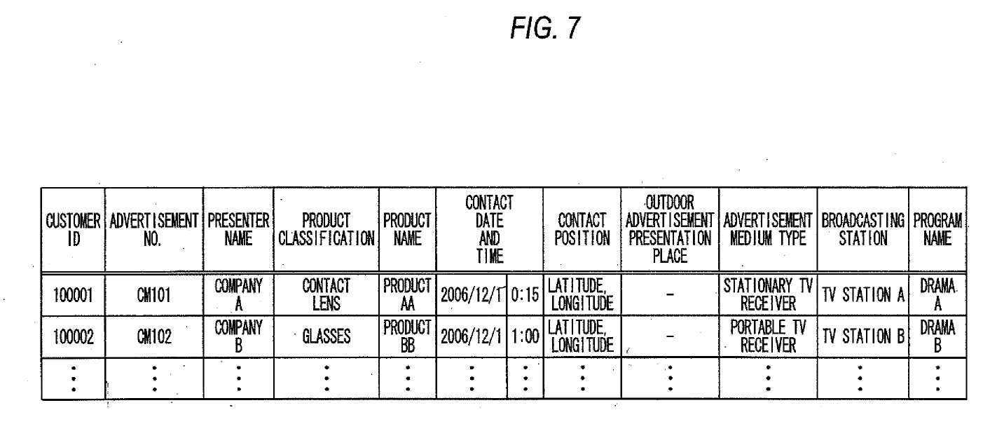

At S31, the broadcast advertisement contact data registering section 52 of the contact advertisement processing server 5 receives the advertisement registration request containing the advertisement number of the advertisement selected by the user, the customer ID, the date/time data, and the position data. At S33, the broadcast advertisement contact data registering section 52 searches the broadcast advertisement DB 54 by the advertisement number, extracts the corresponding advertisement data, and registers the corresponding advertisement data, the customer ID, the date/time data, and the position data in the contact situation DB 55. For example, data as shown in FIG. 7 are stored in the contact situation DB 55. A customer ID, an advertisement number, a presenter name, a product classification, a product name, a contact date and time, a contact position, an outdoor advertisement presentation place, an advertisement medium type, a broadcasting station, and a program name are registered in the exemplary table of FIG. 7. No outdoor advertisement presentation place is registered at S33 because data of a broadcast advertisement is to be registered at S33.

At S35, the broadcast advertisement contact data registering section 52 generates a registration completion notice and sends it to the user terminal 3. At S37, the advertisement registering application program 33 of the user terminal 3 receives the registration completion notice from the contact advertisement processing server 5 and causes the display device to display it. At S39, the execution of the advertisement registering application program 33 is finished automatically or upon reception of a user command.

As a result of execution of the above process, data relating to an advertisement that a user was interested in, a position of that event, an advertisement medium used, etc. is registered. This makes it possible to remind the user about the event by presenting him or her the data relating to the advertisement, the position, the advertisement medium, etc. at the time of purchasing, for example.

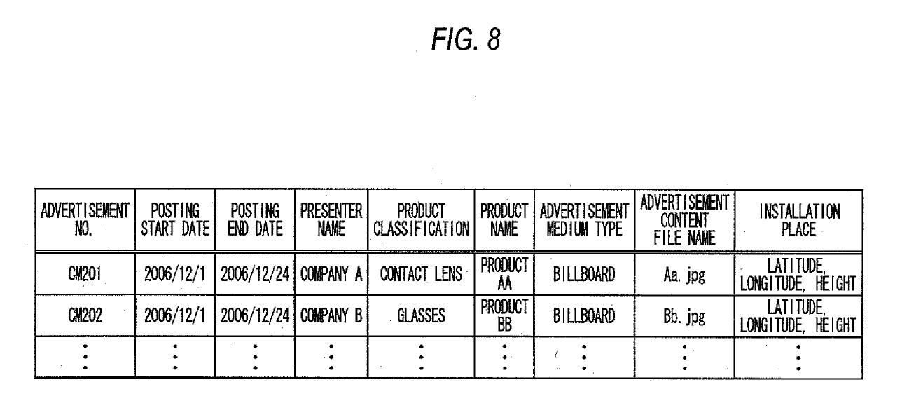

Next, a process that is executed when “outdoor advertisement” is selected as an advertisement medium type at S9 in FIG. 2A will be described with reference to FIG. 2C. At S41, the advertisement registering application program 33 of the user terminal 3 sends the position data and the date/time data to the contact advertisement processing server 5. At S43, the outdoor contact data registering section 53 of the contact advertisement processing server 5 receives the position data and the date/time data from the user terminal 3 and stores those data in a storage memory such as the main memory. At S45, the outdoor contact data registering section 53 searches the outdoor advertisement DB 56 by the position data and the date/time data and extracts suitable outdoor advertisements. For example, data as shown in FIG. 8 are stored in the outdoor advertisement DB 56. In the exemplary table of FIG. 8, data of an advertisement number, a posting start date, a posting end date, a presenter name, a product classification, a product name, an advertisement medium name, an advertisement content file name, and an installation place are registered. The installation place data includes a height in addition to a latitude and a longitude. An advertisement content file itself is also stored in the outdoor advertisement DB 56. At S45, such outdoor advertisements that the installation place is in a prescribed range around the position of the position data and the posting period defined by the posting start date and the posting end date includes the date and time indicated by the date/time data are found.

At S47, the outdoor contact data registering section 53 extracts map data covering a prescribed range from the map database 57 on the basis of the received position data. More specifically, for example, the outdoor contact data registering section 53 extracts map data covering an area having a prescribed radius and centered by the position indicated by the latitude and the longitude that are included in the received position data. For example, map data used is such that display positions of objects indicating presence of outdoor advertisements are registered in advance so as to be correlated with the respective advertisement numbers. At S49, the outdoor contact data registering section 53 sends the outdoor advertisement data extracted at S45 and the map data extracted at S47 to the user terminal 3.

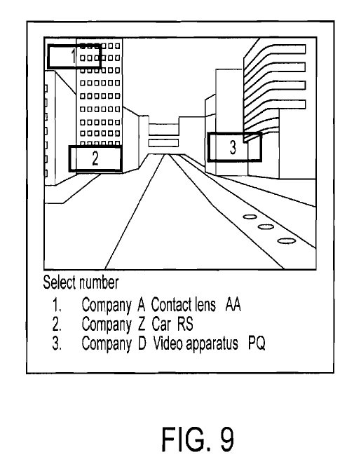

At S51, the advertisement registering application program 33 of the user terminal 3 receives the outdoor advertisement data (e.g., advertisement numbers, advertisement presenter names, product classifications, product names, installation places) and the map data from the contact advertisement processing server 5 and stores those data in a storage device such as the main memory. At S53, the advertisement registering application program 33 generates an advertisement selection picture using the received data and displays it on the display device. For example, a picture as shown in FIG. 9 is displayed on the display device. In the example of FIG. 9, 3D map image data is received and numbered, transparent objects are located at display positions corresponding to the installation places of the outdoor advertisements, respectively. For example, if as mentioned above display positions of objects indicating presence of outdoor advertisements are registered in advance so as to be correlated with the respective advertisement numbers, the advertisement registering application program 33 can display serially numbered, transparent objects on a 3D map image. The presenter names, product classifications, and product names are listed under the map image. In the example of FIG. 9, the user selects one of items 1 to 3 and clicks on it. The technology itself for displaying a display picture as shown in FIG. 9 is known and hence will not be described any further in this embodiment.

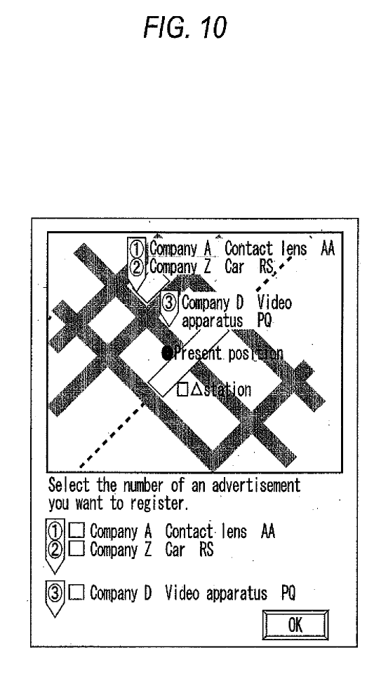

Alternatively, a picture as shown in FIG. 10 may be displayed on the display device. In the example of FIG. 10, pins are located at display positions corresponding to the installation places of the outdoor advertisements, respectively, on a two-dimensional map. Where two or more outdoor advertisements are installed on the same building, pins are integrated and outdoor advertisement numbers are shown in the same pin in descending order of height. In the example of FIG. 10, item 1 is an outdoor advertisement of company A and item 2 is an outdoor advertisement of company B and the former is higher in installation height than the latter. In the example of FIG. 10, not only the places of the outdoor advertisements but also the position of the user is indicated as a “present position” or “contact position.” Furthermore, a list of the outdoor advertisements concerned with check boxes is displayed under the map image. The user checks the check box of one of the outdoor advertisements and clicks on an OK button. For example, the process may be such that if no suitable outdoor advertisement is displayed, position data is acquired again to correct the current position data and then the process returns to S41.

The advertisement registering application program 33 of the user terminal 3 accepts the advertisement selection input of the user at S55, and sends the advertisement number of the selected outdoor advertisement to the contact advertisement processing server 5 at S57. Alternatively, the entire received outdoor advertisement data may be sent back. At S59, the outdoor contact data registering section 53 of the contact advertisement processing server 5 receives the advertisement number from the user terminal 3 and stores it in a storage device such as the main memory. The outdoor contact data registering section 53 searches the outdoor advertisement DB 56 by the received advertisement number and extracts the advertisement content file at S61, and sends it to the user terminal 3 at S63. At S65, the advertisement registering application program 33 of the user terminal 3 receives the advertisement content file from the contact advertisement processing server 5 and stores it in a storage device such as the main memory. Then, the process moves to a part shown in FIG. 2D via diagram connector terminals E and F.

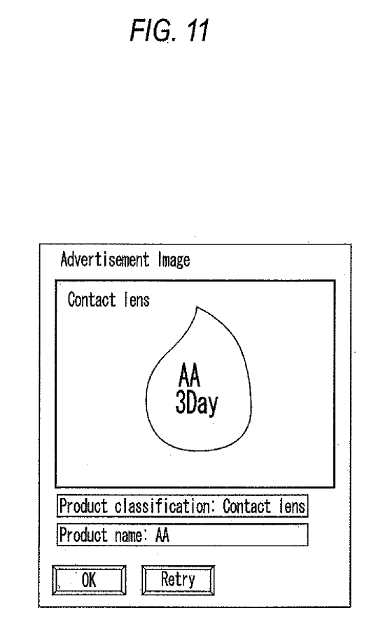

The part of the process shown in FIG. 2D will be described below. At S67, the advertisement registering application program 33 generates a detailed display picture using the received advertisement content file and causes the display device to display the picture. For example, a picture as shown in FIG. 11 is displayed on the display device. In the example of FIG. 11, an image of the advertisement content file is displayed in an upper part of the picture and the product classification and the product name are shown in order in a lower part of the picture. The user clicks on an OK button if he or she decides to register this outdoor advertisement, and clicks on a retry button if he or she decides to select an advertisement again.

If the user clicks on the OK button, the advertisement registering application program 33 judges that a registration command has been given (S69: yes) and sends, to the contact advertisement processing server 5, a registration request containing a customer ID, the position data and the date/time data that were acquired at S3, and the advertisement number at S71. On the other hand, if the user clicks on the retry button (S69: no), the process returns to S53 in FIG. 2C via diagram connector terminal G.

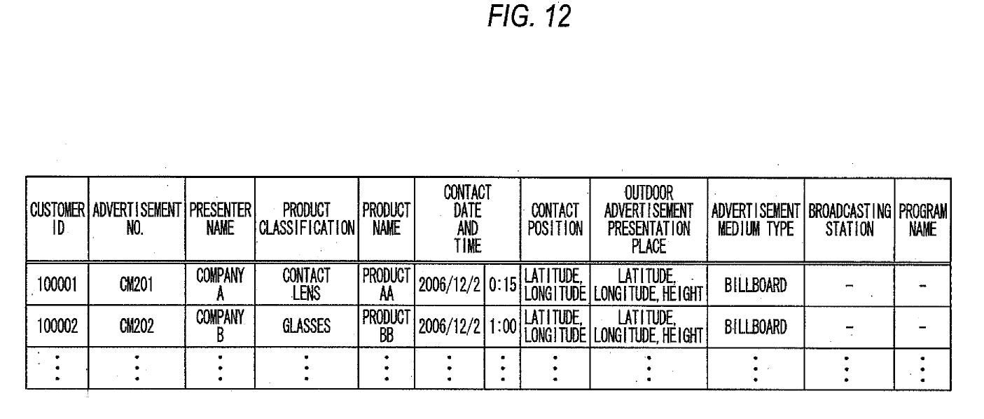

At S73, the outdoor advertisement contact data registering section 53 of the contact advertisement processing server 5 receives from the user terminal 3 the registration request containing the customer ID, the position data, the date/time data, and the advertisement number. At S75, the outdoor advertisement contact data registering section 53 searches the outdoor advertisement DB 56 by the advertisement number, extracts the corresponding advertisement data, and registers the customer ID, the position data, the date/time data, and the advertisement data corresponding to the advertisement number in the contact situation DB 55. In the case of an outdoor advertisement, as shown in FIG. 12, a customer ID, an advertisement number, a presenter name, a product classification, a product name, a contact date and time, a contact position (latitude and longitude), an outdoor advertisement presentation place (latitude, longitude, and height), and an advertisement medium type (billboard) are registered. No broadcasting station or program name is registered because they are irrelevant.

At S77, the outdoor advertisement contact data registering section 53 generates a registration completion notice and sends it to the user terminal 3. At S79, the advertisement registering application program 33 of the user terminal 3 receives the registration completion notice from the contact advertisement processing server 5 and causes the display device to display it. At S81, the execution of the advertisement registering application program 33 is finished automatically or upon reception of a user command.

As a result of execution of the above process, when a user sees an advertisement he or she is interested in while, for example, walking or moving by another method, a position of contact with the advertisement and data relating to the advertisement are registered. This makes it possible to refer to those data at the time of purchasing.

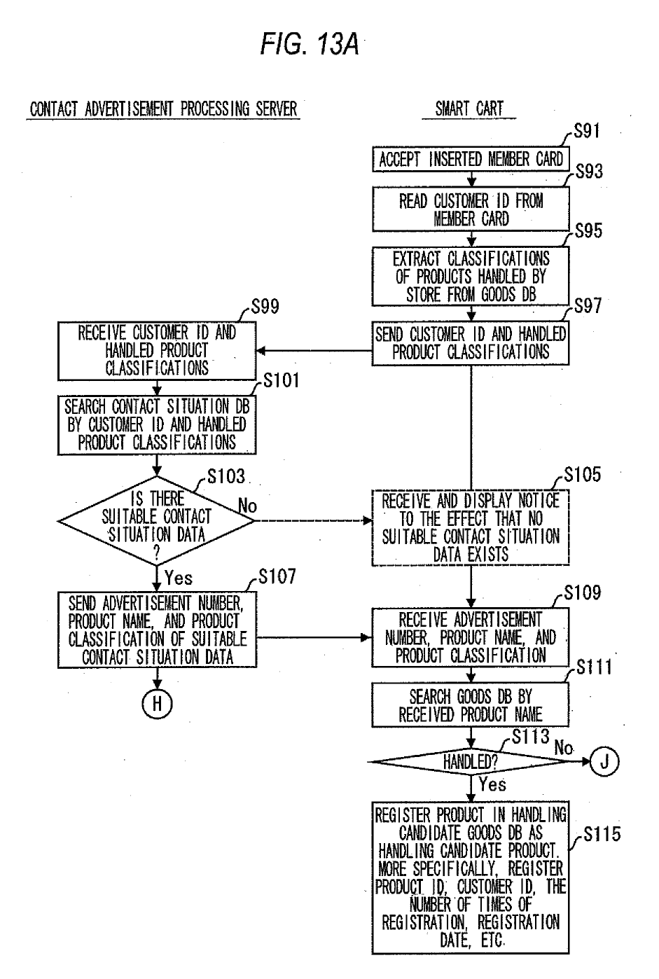

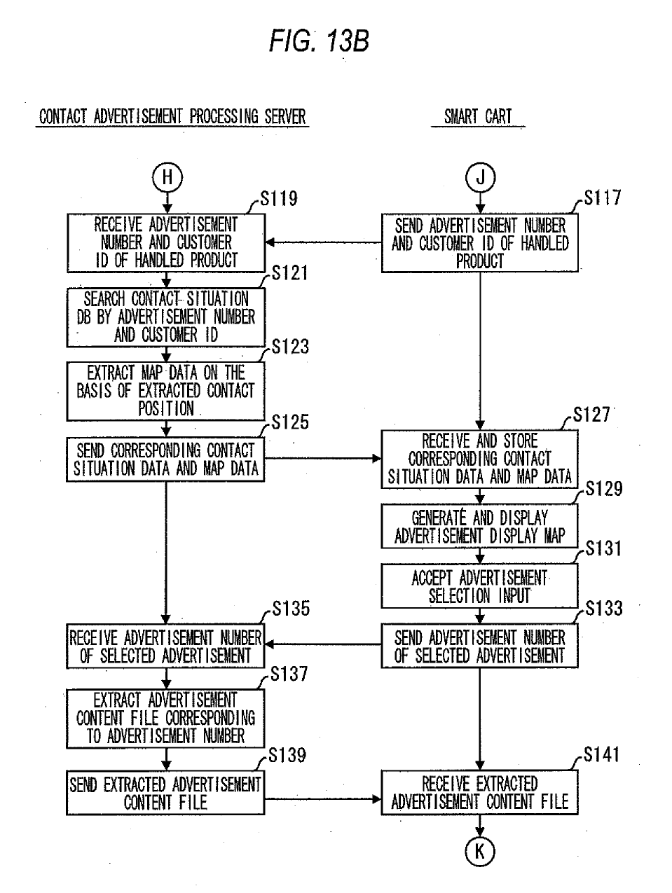

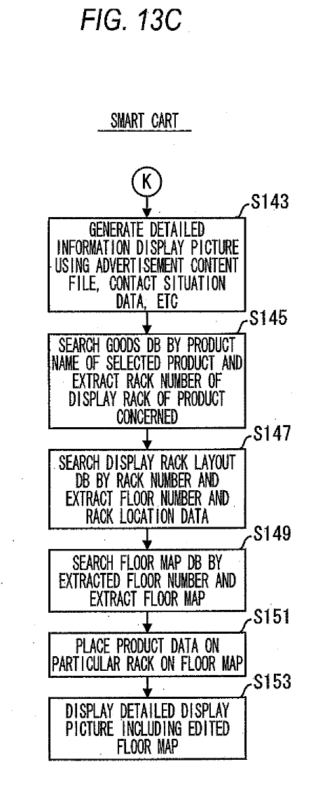

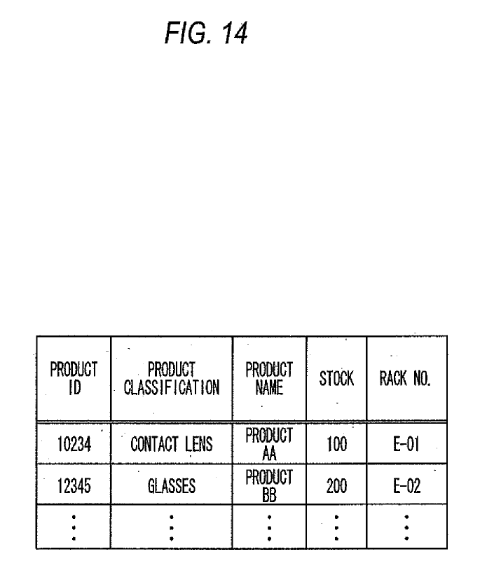

Next, a process which is executed when a user does shopping in a certain store will be described with reference to FIGS. 13A-13C to FIG. 18. First, a user select a smart cart 72 and inserts a member card 73 into the slot of the advertisement terminal 75 that is provided in the smart cart 72. It is assumed that the member card 73 is a magnetic card or an IC card and a customer ID is recorded therein. As shown in FIG. 13A, the advertisement terminal 75 accepts the inserted member card 73 at S91 and reads the customer ID from the member card 73 at. S93. At S95, the advertisement display processing section 751 extracts classifications of products handled by the store from the goods DB 752. For example, the goods DB 752 holds data as shown in FIG. 14. In the example of FIG. 14, a product ID, a product classification, a product name, a stock, and a display rack number are registered. At S95, product classification codes are extracted.

At S97, the advertisement display processing section 751 sends data of the customer ID and the handled product classifications to the contact advertisement processing server 5. At S99, the smart cart processing section 51 of the contact advertisement processing server 5 receives the data of the customer ID and the handled product classifications from the advertisement terminal 75 of the smart cart 72 and stores the data in a storage device such as the main memory. At S101, the smart cart processing section 51 searches the contact situation DB 55 by the received customer ID and handled product classifications. If no suitable contact situation data is found by the search of S101 (S103 no), the smart cart processing section 51 sends, to the advertisement terminal 75, a notice to the effect that no suitable contact situation data exists. At S105, the advertisement display processing section 751 of the advertisement terminal 75 receives, from the contact advertisement processing server 5, the notice to the effect that no suitable contact situation data exists and displays it on the display device. Then, the process is finished.

On the other hand, if suitable contact situation data exists (S103: yes), at S107 the smart cart processing section 51 sends data of the advertisement number, the product name, and the product classification (i.e., part of the suitable contact situation data) to the advertisement terminal 75. At S109, the advertisement display processing section 751 of the advertisement terminal 75 receives the data of the advertisement number, the product name, and the product classification from the contact advertisement processing server 5 and stores the data in a storage device such as the main memory. At S111, the advertisement display processing section 751 searches the goods DB 752 by the received product name. If the product relating to the advertisement that the user came into contact with and was registered is handled (S113: yes), the process moves to a part shown in FIG. 13B via diagram connector terminals H and J.

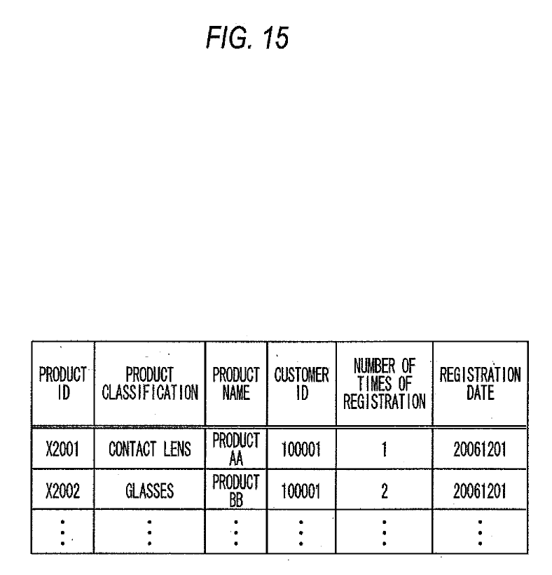

On the other hand, if the product relating to the advertisement that the user came into contact with and was registered is not handled (S113: no), at S115 the product is registered in the handling candidate goods DB 753 as a handling candidate product. More specifically, a product ID, the product classification, the product name, the customer ID, the number of times of registration, and a registration date are registered. For example, data as shown in FIG. 15 is registered in the handling candidate goods DB 753. In the exemplary table of FIG. 15, a product ID, a product classification, a product name, a customer ID, the number of times of registration, and a registration date are registered. For example, the customer ID is used for notifying the user of arrival of the product by mail. Therefore, a customer ID is added every time S115 is executed for the same product. When S115 is executed again for the same product, the number of times of registration is incremented by one. For example, the registration date is a first registration date or an update date.

The part of the process shown in FIG. 13B will be described below. At S117, the advertisement display processing section 751 sends the advertisement number and the customer ID of the handled product to the contact advertisement processing server 5. At S119, the smart cart processing section 51 of the cont a ct advertisement processing server 5 receives the advertisement number and the customer ID of the handled product from the advertisement terminal 75 and stores them in a storage device such as the main memory. At S121, the smart cart processing section 51 searches the contact situation DB 55 by the advertisement number and the customer ID and extracts corresponding contact situation data. At S123, the smart cart processing section 51 extracts map data from the map DB 57 on the basis of the contact position that is included in the extracted contact situation data. At S125, the smart cart processing section 51 sends the corresponding contact situation data and the map data to the advertisement terminal 75.

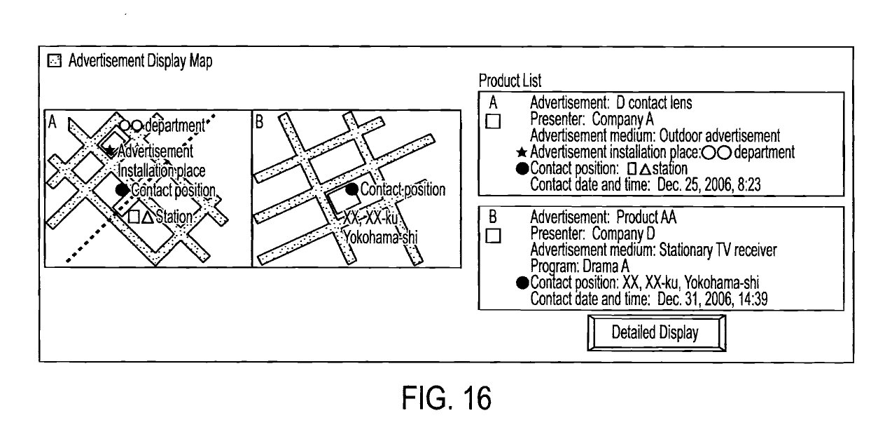

At S127, the advertisement display processing section 751 of the advertisement terminal 75 receives the contact situation data and the map data from the contact advertisement processing server 5 and stores them in a storage device such as the main memory. At S129, the advertisement display processing section 751 generates an advertisement display map and displays it on the display device. FIG. 16 shows an exemplary advertisement display map of a case that two advertisements have been extracted. Maps showing contact situations relating to the two respective advertisements are shown on the left side and detailed data relating to the two advertisements are shown on the right side. More specifically, as for product A, contact was made through an outdoor advertisement and a contact position and an advertisement installation place are shown on the map. As for product B, contact was made through a TV advertisement and a user's home, for example, is shown as a contact position on the map. The user is expected to be reminded of situations of the contact on the basis of the maps and the detailed contact situation data including the advertisement medium types (i.e., data enabling inference of a used terminal or the like). In the example of FIG. 16, check boxes are associated with the respective product names. If the user wants to refer to more detailed data, he or she checks a check box and clicks on a detailed display button.

The advertisement display processing section 751 of the advertisement terminal 75 accepts the advertisement selection input at S131 and sends the advertisement number of the selected advertisement to the contact advertisement processing server 5 at S133. Receiving the advertisement number from the advertisement terminal 75 at S135, the smart cart processing section 51 of the contact advertisement processing server 5 searches the outdoor advertisement DB 56 or the broadcast advertisement DB 54 by the advertisement number and extracts an advertisement content file at S137 and sends the extracted advertisement content file to the advertisement terminal 75 at S139. At S141, the advertisement display processing section 751 of the advertisement terminal 75 receives the advertisement content file from the contact advertisement processing server 5 and stores it in a storage device such as the main memory. Then, the process moves to a part shown in FIG. 13C via diagram connector terminal K.

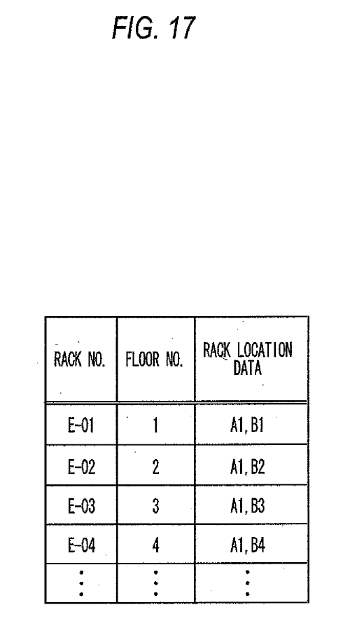

At S143, the advertisement display processing section 751 of the advertisement terminal 75 generates a detailed information display picture using the advertisement content file (moving image, still image, audio data, or the like), the contact situation data, etc. At S145, the advertisement display processing section 751 searches the goods DB 752 by the product name or product ID of the selected product and finds a rack number of a display rack of the product concerned. At S147, the advertisement display processing section 751 searches the display rack layout DB 755 by the rack number and extracts a floor number and rack location data. FIG. 17 shows exemplary data stored in the display rack layout DB 755. In the exemplary table of FIG. 17, a rack number, a floor number, and rack location data (rack coordinates) are registered.

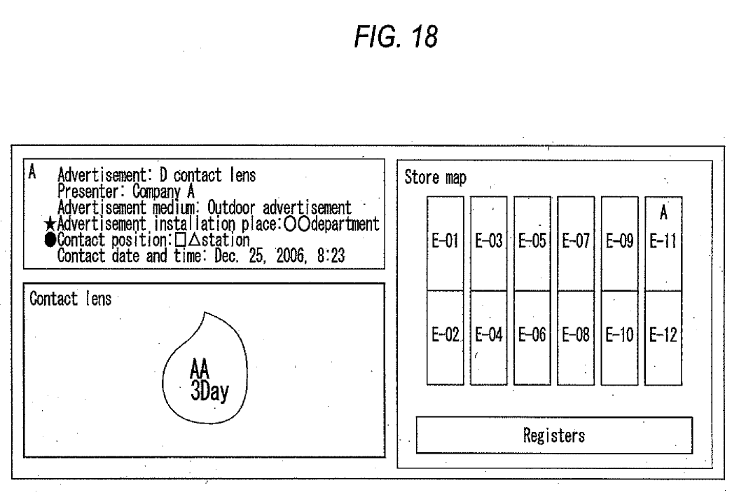

At S149, the advertisement display processing section 751 searches the floor map DB 754 by the extracted floor number and extracts a floor map. At S151, the advertisement display processing section 751 places product data (e.g., product name) on a rack that is located at the position indicated by the rack location data on the floor map. At S153, the advertisement display processing section 751 displays a detailed display picture including the thus-edited floor map on the display device. FIG. 18 shows an exemplary detailed display picture to be displayed in the case where product A, for example, was selected on the advertisement display map. In the exemplary picture of FIG. 18, the data (the same data as in the advertisement display map) included in the contact situation data is shown in a top-left part, the data of the advertisement content file is shown in a bottom-left part, and the floor map (store map) is shown on the right side. The product name “A” is shown in the space of a display rack E-11 on the floor map. In this manner, a customer can be informed of detailed data of a product in which he or she was interested in the past as well as its display location in a store.

Although a user is exposed to various advertisements every day, since an advertisement of a product that the user is interested in is registered by the above-described process, the user can properly be reminded of a position and a situation at and in which he or she felt interest and the fact that he or she felt interest (by referring to the contents of the advertisement) when having a chance for purchasing the product. Since a user is caused to refer to such a product advertisement when having a chance for purchasing the product, the user is prevented from failing in purchasing it. On the other hand, a store is given an advantage that selling of goods is promoted. Furthermore, a store can recognize goods for which customers considered purchase and hence can improve the line of goods efficiently. Still further, by analyzing the contact situation DB 55 later, a store can evaluate responses to an advertisement and can also evaluate, through cooperation with a POS system, whether the advertisement has caused actual purchases. If the advertisement terminal 75 is equipped with a replacement goods DB, a replacement product can be presented even if a product concerned is not handled.

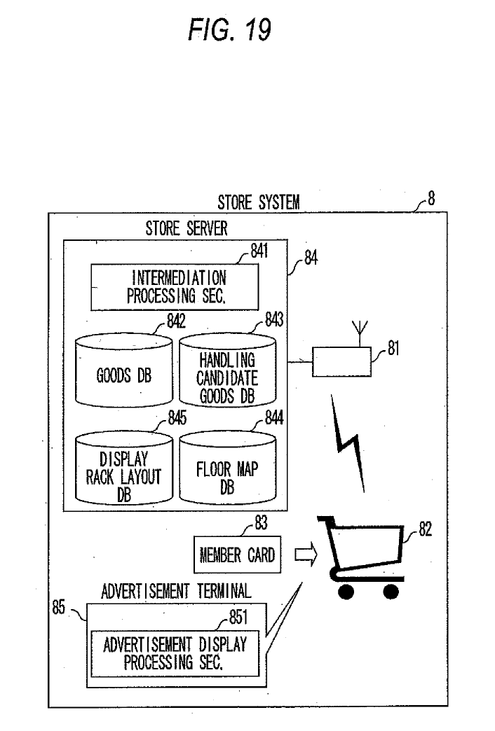

The above-described embodiment is just an example and the invention is not limited to it. For example, the system outline shown in FIG. 1 can be modified to one shown in FIG. 19. That is, the store system 7 is changed to a store system 8. More specifically, the store system 8 is provided with a radio base station 81, a store server 84, and plural smart carts 82. Each smart cart 82 is equipped with an advertisement terminal 85 having an insertion slot for a member card 83. The advertisement terminal 85 is equipped with an advertisement display processing section 851, which may be merely a general-purpose program such as a Web browser. On the other hand, the store server 84 is equipped with an intermediation processing section 841, a goods DB 842 for storing data that are similar to data to be stored in the goods DB 752, a handling candidate goods DB 843 for storing data that are similar to data to be stored in the handling candidate goods DB 753, a display rack layout DB 845 for storing data that are similar to data to be stored in the display rack layout DB 755, and a floor map DB 844 for storing data that are similar to data to be stored in the floor map DB 754. The intermediation processing section 841 exchanges information with the contact advertisement processing server 5 and the advertisement display processing section 851 of each advertisement terminal 85 and generates display data for the advertisement display processing section 851. Pictures displayed on the display device of each advertisement terminal 85 are the same as in the above embodiment.

The advertisement registering application program 33 may also be a general-purpose program such as a Web browser. In this case, each of the broadcast advertisement contact data registering section 52 and the outdoor advertisement contact data registering section 53 is given a Web server function.

There may occur a case that the processing order of operations can be reversed to attain the same function. And there may occur a case that the contents of transmission data can be altered.

For example, the communication load may be lowered by providing the contact advertisement processing server 5 with a database of products handled by each store. There may occur a case that the number of times of information exchange is increased or decreased by employing another method. That is, the number of times of communication between the contact advertisement processing server 5 and the store system 7 is increased or decreased by changing the search method. In particular, although in the above embodiment the process flow is such that candidates are first extracted and presented or evaluated and then next-stage candidates are extracted, there may occur a case that the number of extraction stages is decreased to one or increased to three or more. The above-described functions of the contact advertisement processing server 5 may be realized by either a single computer or plural computers. A store may be either an actual store or a virtual store on a network. In the latter case, the advertisement terminal 75 is integrated with the user terminal 3. An order page for a product concerned may be popped up instead of showing display racks. The communication load can be lowered by providing a map DB in the advertisement terminal 75. Although in the above embodiment a member card 73 is inserted into the advertisement terminal 75, authentication may be performed using an ID and a password. Furthermore, the above-described pictures are just examples and pictures may be used each of which has the same contents but is different in structure from the above embodiment.

The user terminal 3 need not necessarily be a cell phone and may be a personal computer, for example. In the latter case, the contact advertisement processing server 5 is provided with a function of determining a latitude and a longitude from an input address, for example.

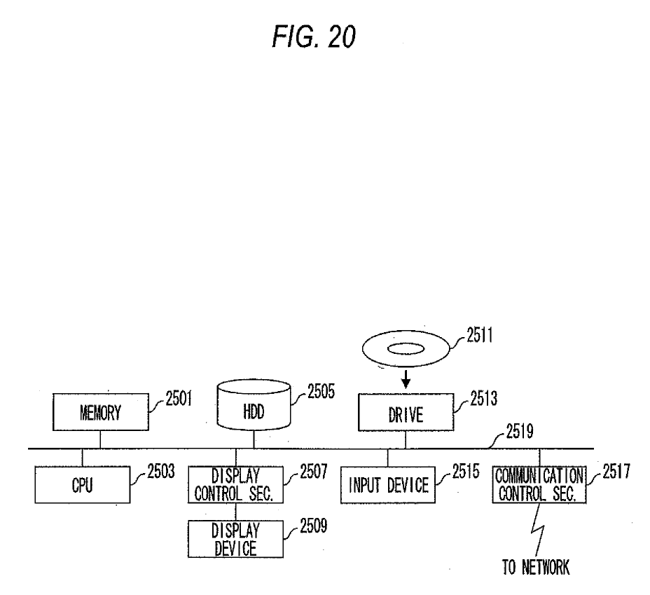

For example, the contact advertisement processing server 5 is a computer in which, as shown in FIG. 20, a memory 2501 (storage section), a CPU 2503 (processing section), a hard disk drive (HDD) 2505, a display control section 2507 which is connected to a display device 2509, a drive 2513 for a removable disc 2511, an input device 2515, and a communication control section 2517 for connection to a network are connected to each other via a bus 2519. The operating system (OS) and application programs including a Web browser are stored in the HDD 2505, and read from the HDD 2505 into the memory 2501 when they are to be run by the CPU 2503. When necessary, the CPU 2503 controls the display control section 2507, the communication control section 2517, or the drive 2513 to cause it to perform a necessary operation. Data that occurs during processing is basically stored in the memory 2501 and stored in the HDD 2505 if necessary. The thus-configured computer realizes the above-described various functions in such a manner that the hardware such as the CPU 2503 and the memory 2501, the OS, and the necessary application programs cooperate in an organic manner. The advertisement terminal 75 also has a configuration as shown in FIG. 20.

Programs for causing computers to perform the above-described methods can be generated, and are stored in a storage medium or a storage device such as a flexible disk, a CD-ROM, a magneto-optical disc, a semiconductor memory, or a hard disk drive or distributed over a network or the like in the form of a digital signal. An intermediate processing result is temporarily stored in a storage device such as the main memory. The embodiments can be implemented in computing hardware and/or software. Any combinations of the described embodiment features can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. An advertisement processing method which is performed by a computer, comprising:
accepting an extraction request including a customer ID of a particular customer and conditions relating to products that are handled by a store and may be purchased by the particular customer;
storing in a contact advertisement data storage advertisement contact situation data including data relating to advertisements registered by customers as correlated with customer IDs of the customers and data relating to situations in which the customers came into contact with the respective advertisements;
searching the contact advertisement data storage by the customer ID of the particular customer and the conditions relating to the products that are handled by the store and may be purchased by the particular customer, and extracting suitable advertisement contact situation data; and
outputting at least part of the extracted advertisement contact situation data.

2. The advertisement processing method according to claim 1, wherein if the conditions relating to the products that are handled by the store and may be purchased by the particular customer are classifications of the handled products, the extracting comprises extracting suitable advertisement contact situation data by searching the contact advertisement data storage section by the customer ID of the particular customer, and narrowing a search result by comparing product classifications included in the data relating to the advertisements included in the extracted advertisement contact situation data with the classifications of the handled products.

3. The advertisement processing method according to claim 1, wherein if the conditions relating to the products that are handled by the store and may be purchased by the particular customer are advertisement identification data of the handled products, the extracting comprises extracting suitable advertisement contact situation data by searching the contact advertisement data storage section by the customer ID of the particular customer, and narrowing a search result by comparing advertisement identification data included in the data relating to the advertisements included in the extracted advertisement contact situation data with the advertisement identification data of the handled products.

4. The advertisement processing method according to claim 1, further comprising:
accessing a map data storage in which map data are stored,
extracting map data of suitable areas from the map data storage based upon contact positions included in the data relating to the situations in which the customers came into contact with the advertisements that are included in the extracted advertisement contact situation data, and
outputting the extracted map data.

5. The advertisement processing method according to claim 1, wherein each piece of the data relating to the situations in which the customers came into contact with the advertisements includes a position, a date and/or time for where and when a customer came into contact with an advertisement, or an advertisement medium type of the advertisement, or any combinations thereof.

6. The advertisement processing method according to claim 1, further comprising:
accessing an outdoor advertisement data storage in which installation place data, posting period data, and advertisement data are stored for respective outdoor advertisements,
when position data and date/time data are received from a user terminal, searching the outdoor advertisement data storage by the position data and the date/time data, and extracting outdoor advertisements whose installation places are within a prescribed range of a position indicated by the position data and whose posting periods includes a date and time indicated by the date/time data,
sending the advertisement data of the extracted outdoor advertisements to the user terminal; and
storing, in the contact advertisement storage section, the advertisement data of an outdoor advertisement corresponding to a selection command from the user terminal, a customer ID of a person who manipulates the user terminal, the position data, and the date/time data.

7. The advertisement processing method according to claim 1, further comprising:
accessing a broadcast advertisement data storage in which broadcast times, broadcast medium data, and advertisement data are stored for respective broadcast advertisements,
when date/time data and broadcast medium data are received from a user terminal, searching the broadcast advertisement data storage by the date/time data and the broadcast medium data, and extracting broadcast advertisements whose broadcasting times include a date and time indicated by the date/time data and whose broadcast medium data coincide with the received broadcast medium data,
sending the advertisement data of the extracted broadcast advertisements to the user terminal, and
storing, in the contact advertisement storage, the advertisement data of a broadcast advertisement corresponding to a selection command from the user terminal, a customer ID of a person who manipulates the user terminal, the date/time data, the broadcast medium data, and the position data of the user terminal.

8. An advertisement display method which is performed by a store computer used in a store, comprising:
acquiring a customer ID of a particular customer;
acquiring conditions relating to products that are handled by the store and may be purchased by the particular customer;
sending an extraction request including the customer ID of the particular customer and the conditions relating to the products that are handled by the store and may be purchased by the particular customer to a contact advertisement processing server which holds advertisement contact situation data including data relating to advertisements registered by the particular customer and data relating to situations in which the particular customer came into contact with the respective advertisements;
receiving at least part of advertisement contact situation data that conform to the extraction request, and storing them in a storage device; and
displaying at least part of the advertisement contact situation data stored in the storage device to the particular customer.

9. The advertisement display method according to claim 8, wherein the receiving receives map data of suitable areas that have been extracted based upon contact positions included in the data relating to the situations in which the particular customer came into contact with the respective advertisements that are included in the advertisement contact situation data that conform to the extraction request, and wherein the displaying displays the map data in such a manner that they are correlated with the advertisement contact situation data.

10. The advertisement display method according to claim 9, wherein the contact positions are shown on the displayed map data.

11. The advertisement display method according to claim 8, further comprising:
when one of products relating to the advertisement contact situation data is selected, searching goods data storage section in which goods data including data relating to an in-store layout of the products handled by the store are stored by the selected product, and finding data relating to an in-store location of the selected product; and
displaying a floor map of the store in such a manner that a mark indicating the in-store location of the selected product is shown on the floor map according to the thus-found data relating to the in-store location of the selected product.

12. The advertisement display method according to claim 8, further comprising
when one of the advertisements relating to the advertisement contact situation data is selected, sending a content request for the selected advertisement to the contact advertisement processing server; and
receiving contents of the selected advertisement from the contact advertisement processing server and displaying the contents on a display device.

13. The advertisement display method according to claim 8, further comprising
if the conditions relating to the products that are handled by the store and may be purchased by the particular customer are classifications of the handled products, searching a goods data storage section in which data of the products handled by the store are stored by identification data of products relating to the advertisement contact situation data received by the receiving step,
judging whether the products relating to the received advertisement contact situation data are handled by the store; and
if judging that a product relating to the received advertisement contact situation data is not handled by the store, storing the customer ID of the particular customer and the identification data of the thus-judged product in a handling candidate goods data storage section as a handling candidate product.

14. A storage medium in which a program for causing a computer to perform the advertisement processing method according to claim 1 is stored.

15. A storage medium in which a program for causing a computer to perform the advertisement display method according to claim 8 is stored.

16. A contact advertisement presentation system comprising a contact advertisement processing apparatus and a store computer system used in a store, wherein:
the store computer system comprises:
first means for acquiring a customer ID of a particular customer;
second means for acquiring conditions relating to products that are handled by the store and may be purchased by the particular customer; and
third means for sending, to the contact advertisement processing apparatus, an extraction request including the customer ID of the particular customer and the conditions relating to the products that are handled by the store and may be purchased by the particular customer;
the contact advertisement processing apparatus comprises:
a contact advertisement data storage section in which advertisement contact situation data including data relating to advertisements registered by customers as correlated with customer IDs of the customers and data relating to situations in which the customers came into contact with the respective advertisements are stored;
means for receiving the extraction request including the customer ID of the particular customer and the conditions relating to the products that are handled by the store and may be purchased by the particular customer; and
extracting means for searching the contact advertisement data storage section by the customer ID of the particular customer and the conditions relating to the products that are handled by the store and may be purchased by the particular customer, extracting suitable advertisement contact situation data, and outputting at least part of the extracted advertisement contact situation data to the store computer system, and wherein:
the store computer system further comprises:
fourth means for receiving the at least part of the advertisement contact situation data from the contact advertisement processing apparatus, and storing them in a storage device; and
fifth means for displaying at least part of the advertisement contact situation data stored in the storage device to the particular customer.

17. The contact advertisement presentation system according to claim 16, wherein the store computer system further comprises shopping carts each being equipped with an advertisement display terminal comprising a display device and the first to fifth means.

18. An apparatus, comprising:
a computer readable medium storing advertisement contact situation data including data relating to advertisements registered by customers as correlated with customer IDs of the customers and data relating to situations in which the customers came into contact with the respective advertisements; and
a controller
processing an extraction request including a customer ID of a particular customer and conditions relating to products that are handled by a store and may be purchased by the particular customer;
searching the contact advertisement data storage by the customer ID of the particular customer and the conditions relating to the products that are handled by the store and may be purchased by the particular customer, and extracting suitable advertisement contact situation data; and
outputting information related to the extracted advertisement contact situation data.
